(19) United States
(12) Patent Application Publication
(10) Pub. No.: US 2015/0356896 A1
(43) Pub. Date: Dec. 10, 2015

(54) APPARATUS AND METHOD FOR IMAGE ANALYSIS AND IMAGE DISPLAY

(71) Applicant: Wistron Corporation, New Taipei City (TW)

(72) Inventors: Meng-Chao Kao, New Taipei City (TW); Tsang-Hsing Lee, New Taipei City (TW); Tzu-Chiang Shen, New Taipei City (TW); Hui-Chen Lin, New Taipei City (TW)

(21) Appl. No.: 14/339,472

(22) Filed: Jul. 24, 2014

(30) Foreign Application Priority Data
Jun. 5, 2014 (TW) 103119594

(51) Int. Cl. G09G 3/00; G06T 7/40; G06T 5/00

(52) U.S. Cl. CPC G09G 3/006; G06T 5/005; G06T 7/408; G09G 2320/0233; G09G 2340/10; G09G 2320/041

(57) ABSTRACT

Apparatuses and methods for image analysis and image display are provided. The image display apparatus includes a storage device, a thermo sensor, a processor, and a display. The storage device stores at least one gain table. Each gain table includes a plurality of gain values. A correspondence relationship is provided between the gain values and a plurality of pixels of an image. The thermo sensor measures an ambient temperature. For each pixel, the processor determines a gain value corresponding to the pixel according to the at least one gain table and the ambient temperature. The processor compensates the image according to the gain values corresponding to the pixels. The display displays the compensated image.

### CROSS-REFERENCE TO RELATED APPLICATION

This application claims the priority benefit of Taiwan application serial no. 103119594, filed on Jun. 5, 2014. The entirety of the above-mentioned patent application is hereby incorporated by reference herein and made a part of this specification.

### BACKGROUND

1. Field

The disclosure relates to apparatuses and methods for image processing, and more particularly, relates to apparatuses and methods for image analysis and image display.

2. Description of Related Art

In some flat-panel displays, a mura with uneven brightness (i.e., in which some regions are brighter, some regions are darker, and the brighter regions and the darker regions are distributed irregularly) may occur even if a displayed image has only one single color. This uneven brightness may be caused by poor design in light field of backlight of the display, unevenness of optical films (e.g., a light guide plate and diffuser plate), or even caused by dirt at inner side of the display.

Unlike obvious defects (i.e., defect pixel, broken line, etc.) or specification (i.e., brightness and chrominance), the uneven brightness is mainly detected by the human eye, and such subjective judgment may be inconsistent and prone to controversy. When the uneven brightness of the display becomes too obvious, purchase of the display may be returned by the consumer who find it unacceptable, or the display may be marked with lower quality level to affect overall price of such display.

The uneven brightness may be solved by increasing a diffusion degree of the optical films in the display, but a cost thereof is increased accordingly.

### SUMMARY

The disclosure is directed to apparatuses and methods for image analysis and image display, which are capable of eliminating or reducing uneven brightness for a display.

An image analysis apparatus of the disclosure includes an image capturing device, a processor and a storage device. The image capturing device captures a first image displayed by a display to generate a second image. The processor is coupled to the image capturing device, finds a minimum value among a plurality of brightness values of a plurality of pixels of the second image, and generates a gain table according to the minimum value. Each of the pixels of the second image is corresponding to one of a plurality of gain values in the gain table. The storage device is coupled to the processor, and stores the gain table.

An image display apparatus of the disclosure includes a storage device, a thermo sensor, a processor, and a display. The storage device stores at least one gain table. Each of the at least one gain table includes a plurality of gain values, and a correspondence relationship is provided between the gain values and a plurality of pixels of an image. The thermo sensor measures an ambient temperature. The processor is coupled to the storage device and the thermo sensor. For each pixel, the processor determines a gain value corresponding to the one of the pixels according to the at least one gain table and the ambient temperature. The processor compensates the image according to the gain values corresponding to the pixels. The display is coupled to the processor, and displays the compensated image.

An image analysis method of the disclosure includes the following steps. A first image displayed by a display is captured to generate a second image. A minimum value among a plurality of brightness values of a plurality of pixels of the second image is found. A gain table is generated according to the minimum value, wherein each of the pixels of the second image is corresponding to one of a plurality of gain values in the gain table. The gain table is stored.

An image display method includes the following steps. At least one gain table is stored, wherein each of the at least one gain table includes a plurality of gain values, and a correspondence relationship is provided between the gain values and a plurality of pixels of an image. An ambient temperature is measured. For each of the pixels, a gain value corresponding to the one of the pixels is determined according to the at least one gain table and the ambient temperature. The image is compensated according to the gain values corresponding to the pixels. The compensated image is displayed.

### BRIEF DESCRIPTION OF THE DRAWINGS

FIG. 1 is a schematic view of an image analysis apparatus according to an embodiment of the disclosure.

FIG. 2 is a flowchart of an image analysis method according to an embodiment of the disclosure.

FIG. 3 is a schematic view of an image display apparatus according to an embodiment of the disclosure.

FIG. 4 is a flowchart of an image display method according to an embodiment of the disclosure.

### DESCRIPTION OF THE EMBODIMENTS

The disclosure utilizes an image signal processing method to perform a compensation (for brighter or dimmer) on pixels in an image displayed by a display, so as to eliminate or reduce an uneven brightness for the display. However, the uneven brightness is under influences of an ambient temperature. Even after the image is compensated, under different ambient temperatures, distribution of the brighter regions and darker regions when the uneven brightness occurs may still vary in different degrees. Therefore, by taking the ambient temperature in consideration, the disclosure is capable of performing different degrees of the compensation for different ambient temperatures.

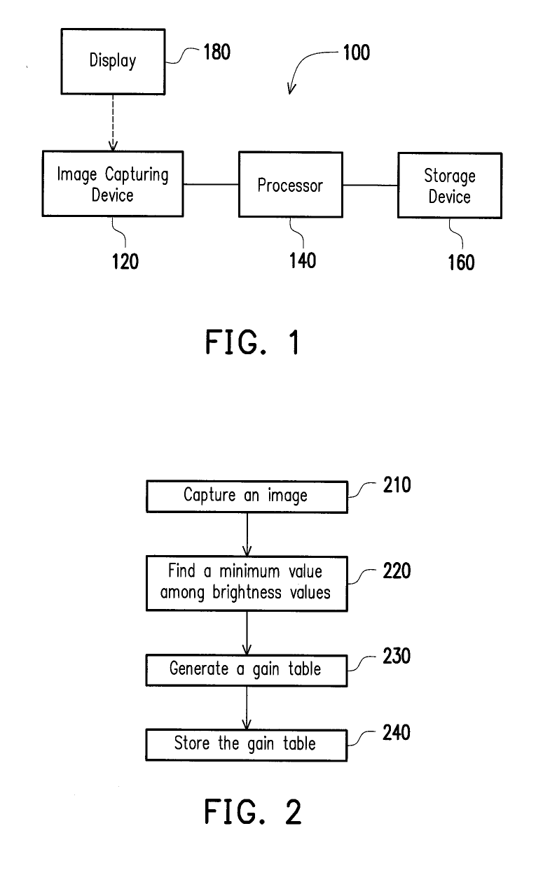

FIG. 1 is a schematic view of an image analysis apparatus 100 according to an embodiment of the disclosure. The image analysis apparatus 100 includes an image capturing device 120, a processor 140 and a storage device 160. The processor 140 is coupled to the image capturing device 120 and the storage device 160. The image capturing device 120 may be any electronic apparatus capable of converting received light signals into digital images, such as a digital camera. The storage device 160 may be any electronic apparatus capable of storing data, such as a memory or a disk drive.

FIG. 2 is a flowchart of an image analysis method according to an embodiment of the disclosure. The image analysis method of FIG. 2 may be executed by the image analysis apparatus 100. In step 210, the image capturing device 120 captures an image I₁ displayed by a display 180 to generate an image I₂. The display 180 may be coupled to the processor 140 and controlled by the processor 140. The display 180 may also be controlled by another electronic apparatus.

Step 210 aims to measure the uneven brightness for the display 180. The image I₁ may be a black and white image or a color image. In case the image I₁ is the black and white image, each pixel of the image I₁ includes only one gray level value. In case the image I₁ is the color image, each pixel of the image I₁ includes a plurality of gray level values. For example, in a normal color display, each pixel includes three gray level values corresponding to red, green and blue, respectively. In order to accurately measure the uneven brightness for the display 180, the image I₁ may be an even white image or an even gray image. In other words, all gray level values of all pixels of the image I₁ may be the same value.

The image I₂ includes a plurality of pixels. If the uneven brightness occurs in the display 180, the pixels of the image I₂ may include a plurality of different brightness values instead of one single brightness value. The processor 140 may find a minimum value among the brightness values of the pixels of the image I₂ in step 220, and then generate a gain table according to the minimum value in step 230. The storage device 160 may store the gain table in step 240.

The image I₁ and the image I₂ each is a two-dimensional array composed of pixels, and the gain table is a two-dimensional array composed of a plurality of gain values. The pixel of the image I₁ is corresponding to a gain value at the same position in the gain table. The pixel of the image I₂ is also corresponding to a gain value at the same position in the gain table. Each of the gain values in the gain table is equal to the minimum value among the brightness values of the pixels of the image I₂ divided by the brightness value of the pixel of the image I₂ corresponding to the gain value.

For instance, it is assumed that the image I₁ is an all-white image. In other words, each gray level value of each pixel of the image I₁ is a maximum gray level value corresponding to a gray level resolution of the image I₁. In case the gray level resolution of the image I₁ is 8-bit, the corresponding maximum gray level value is 255. It is assumed herein that the ambient temperature at the time is 0° C. The processor 140 may find a maximum value and a minimum value among the brightness values of the pixels of the image I₂ (it is assumed that the maximum value is 479 and the minimum value is 294 herein). Because the all-white image is already the brightest image, the pixels therein cannot be brighter but only dimmer. In order to make the compensated image to include an even brightness, the minimum value 294 among the brightness values of the pixel is used to generate the gain table. As a simple example, which is provided below and assuming that dimensions of the image I₁, the image I₂ and the gain table are all 6×4. Table 1 below lists the brightness values of the pixels of the image I₂, and Table 2 is the gain table. Each of the gain values in Table 2 is equal to the minimum value 294 divided by the brightness value of the pixel of image I₂ corresponding to the gain value. The temperature corresponding to the generated gain table is 0° C.

TABLE 1
the brightness values of the pixels of the image I₂

| | | | | | |
|---|---|---|---|---|---|
| 380 | 475 | 468 | 441 | 426 | 294 |
| 466 | 479 | 472 | 452 | 398 | 305 |
| 395 | 433 | 462 | 404 | 325 | 317 |
| 321 | 384 | 360 | 365 | 310 | 294 |

TABLE 2
the gain table

| | | | | | |
|---|---|---|---|---|---|
| 0.64 | 0.62 | 0.63 | 0.67 | 0.69 | 1.00 |
| 0.63 | 0.61 | 0.63 | 0.65 | 0.74 | 0.96 |
| 0.74 | 0.68 | 0.64 | 0.73 | 0.90 | 0.93 |
| 0.92 | 0.77 | 0.67 | 0.81 | 0.95 | 1.00 |

The image analysis device 100 may execute the image analysis method of FIG. 2 for a plurality of times to generate a plurality of gain tables, wherein each of the gain tables is corresponding to a different temperature, and used to compensate the image for different ambient temperatures. For instance, the image analysis apparatus 100 may execute the image analysis method of FIG. 2 again on the same image I₁ under the ambient temperature of 25° C. It is assumed that among the brightness values of the pixels of the image I₂ captured by executing step 210 this time, the maximum value is 471 and the minimum value is 284. Accordingly, another gain table may be generated by using this minimum value 284 and the same method as described above. The temperature corresponding to the generated gain table is 25° C.

As another example, the image analysis apparatus 100 may execute the image analysis method of FIG. 2 again on the same image I₁ under the ambient temperature of 50° C. It is assumed that among the brightness values of the pixels of the image I₂ captured by executing step 210 this time, the maximum value is 461 and the minimum value is 275. Accordingly, another gain table may be generated by using this minimum value 275 and the same method as described above. The temperature corresponding to the generated gain table is 50° C.

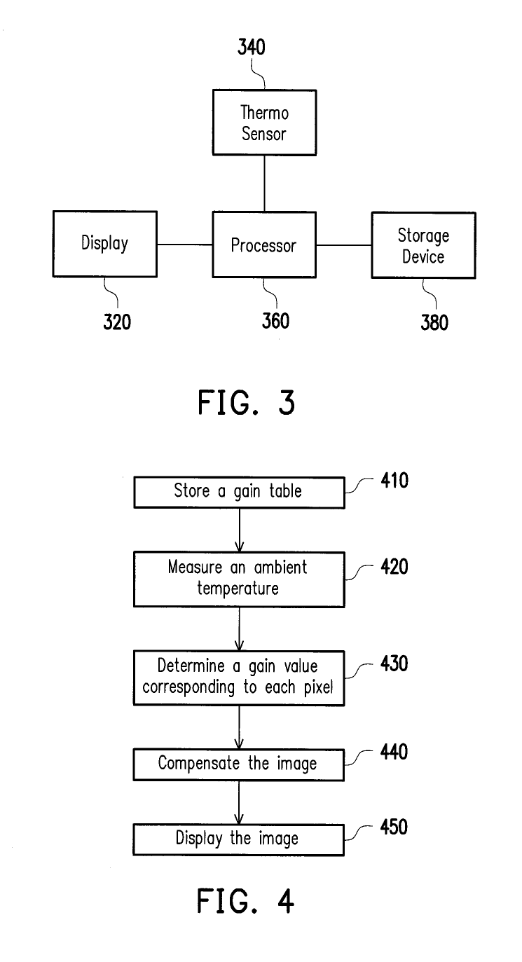

FIG. 3 is a schematic view of an image display apparatus 300 according to an embodiment of the disclosure. The image display apparatus 300 includes a display 300, a thermo sensor 340, a processor 360 and a storage device 380. The processor 360 is coupled to the display 320, the thermo sensor 340 and the storage device 380. In order to effectively eliminate or reduce the uneven brightness, the display 320 should have a brightness distribution identical or similar to that of the display 180. For example, the display 320 and the display 180 may be displays with the same brand and model, or displays manufactured in the same process, or the same display.

FIG. 4 is a flowchart of an image display method according to an embodiment of the disclosure. The image display method of FIG. 4 may be executed by the image display apparatus 300. The storage device 380 stores at least one gain table generated by the image analysis apparatus 100 in step 410. Each of the at least one gain table includes a plurality of gain values, and a correspondence relationship is provided between the gain values and a plurality of pixels of an image I displayed by the display 320. Each pixel of the image I is corresponding to a gain value in each gain table. The thermo sensor 340 measures an ambient temperature in step 420. For each pixel in the image I, the processor 360 determines a gain value corresponding to the pixel according to the ambient temperature and the at least one gain table stored in the storage device 380 in step 430. For each of the pixels, the processor 360 multiplies each gray level value of the pixel by the gain value corresponding to the pixel in step 440, so as to compensate the image I. In above-said compensation, each of the gray level values of the same pixels is multiplied by the same gain value (i.e., the gain value corresponding to the pixel). The display 320 displays the compensated image I in step 450.

The method for the processor 360 to determine the gain value corresponding to each pixel according to the gain table is described as follows. It is assumed that an ambient temperature measured by the thermo sensor 340 is T, and the processor 360 needs to determine a gain value G_{P} corresponding to a specific pixel P of the image I. As described above, each of the gain tables stored in the storage device 380 is corresponding to a temperature. If the ambient temperature T is equal to the temperature corresponding to a specific gain table, the gain value G_{P} corresponding to the pixel P is a gain value corresponding to the pixel P in the specific gain table. The processor 360 multiplies each gray level value of the pixel P by the gain value G_{P} corresponding to the pixel P in step 440, so as to compensate the image I.

For instance, it is assumed that three gain tables are stored in the storage device 380, wherein the temperature corresponding to a first gain table is 0° C., the temperature corresponding to a second gain table is 25° C., and the temperature corresponding to a third gain table is 50° C. When the ambient temperature T is 0° C., the gain value G_{P} is the gain value corresponding to pixel P in the first gain table. When the ambient temperature T is 25° C., the gain value G_{P} is the gain value corresponding to pixel P in the second gain table, and the rest may be deduced by analogy.

On the other hand, when the ambient temperature T is not equal to the temperature corresponding to each of the gain tables, for each pixel P of the image I, the processor 360 calculates the gain value G_{P} corresponding to the pixel P according to the at least one temperature corresponding to the at least one gain table stored in the storage device 380, the ambient temperature T, and at least one gain value corresponding to the pixel P in the at least one gain table.

In the foregoing examples, when the ambient temperature T is neither 0° C., 25° C. nor 50° C., the processor 360 may utilize the three gain tables and an interpolation to calculate the gain value G_{P} corresponding to the pixel P. In case the ambient temperature T is between 50° C. and 25° C., the processor 360 may calculate the gain value G_{P} by using a formula (1) as provided below.

G_{P}=((T−25)×G50+(50−T)×G25)/(50−25) (1)

In the formula (1), G₅₀ is the gain value corresponding to the pixel P in the third gain table, and G₂₅ is the gain value corresponding to the pixel P in the second gain table.

In case the ambient temperature T is between 25° C. and 0° C., the processor 360 may calculate the gain value G_{P} by using a formula (2) as provided below.

G_{P}=(T×G25+(25−T)×G0)/(25−0) (2)

In the formula (2), G₀ is the gain value corresponding to the pixel P in the first gain table.

In view of the description for the method of FIG. 2, it can be known that each of the gain values in each of the gain tables aims to adjust the pixels located in the brighter regions to be dimmer, or adjust the pixels located in the darker regions to be brighter. Therefore, by utilizing the corresponding gain value to compensate each gray level value of each pixel, the pixel with the same color may be displayed with consistent brightness, regardless of where it is positioned, so as eliminate or reduce the uneven brightness for the display.

Although three gain tables are used in the foregoing embodiment, the disclosure is not intended to limit a quantity of the gain tables. In other embodiments, the image analysis apparatus 100 may generate any number of the gain tables, and the image display apparatus 300 may also use any number of the gain tables. Compensation quality may be higher when the quantity of the gain tables is greater. If the quantity of the gain tables is relatively fewer, resulting that the ambient temperature T does not have a corresponding gain table, the processor 360 may calculate the gain value G_{P} by using the interpolation as described above. Alternatively, the processor 360 may also calculate the gain value G_{P} according to the existing gain tables by using methods such as an extrapolation or a curve fitting.

In summary, the disclosure is capable of detecting and analyzing differences between displayed brightnesses of the pixels due to the uneven brightness for generating a gain table, and compensating the image by using the gain table The disclosure is also capable of measuring the ambient temperature according to the thermo sensor, and adaptively performing different degrees of the compensation for different ambient temperatures, such that a result of the compensation may provide image frames for meeting expectation. Because the disclosure does not require changes in hardware design of the display, a hardware cost for the display will not be increased.

What is claimed is:

1. An image display apparatus, comprising:
a storage device, storing at least one gain table, wherein each of the at least one gain table includes a plurality of gain values, and a correspondence relationship is provided between the gain values and a plurality of pixels of an image;
a thermo sensor, measuring an ambient temperature;
a processor, coupled to the storage device and the thermo sensor, and for each of the pixels, the processor determining a gain value corresponding to the one of the pixels according to the at least one gain table and the ambient temperature, and the processor compensating the image according to the gain values corresponding to the pixels; and
a display, coupled to the processor, and displaying the compensated image.

2. The image display apparatus of claim 1, wherein each of the at least one gain table is corresponding to a temperature, and when the ambient temperature is equal to the temperature corresponding to one of the at least one gain table, for each of the pixels, the gain value corresponding to the one of the pixels used to compensate the image is the gain value corresponding to the one of the pixels in the one of the at least one gain table.

3. The image display apparatus of claim 2, wherein for each of the pixels, the processor multiplies each gray level value of the one of the pixels by the gain value corresponding to the one of the pixels, so as to compensate the image.

4. The image display apparatus of claim 1, wherein each of the at least one gain table is corresponding to a temperature, and when the ambient temperature is not equal to the temperature corresponding to each of the at least one gain table, for each of the pixels, the processor calculates the gain value corresponding to the one of the pixels used to compensate the image according to the at least one temperature corresponding to the at least one gain table, the ambient temperature, and at least one gain value corresponding to the one of the pixels in the at least one gain table.

5. The image display apparatus of claim 4, wherein for each of the pixels, the processor multiplies each gray level value of the one of the pixels by the gain value corresponding to the one of the pixels, so as to compensate the image.

6. An image display method, comprising:
storing at least one gain table, wherein each of the at least one gain table includes a plurality of gain values, and a correspondence relationship is provided between the gain values and a plurality of pixels of an image;
measuring an ambient temperature;
for each of the pixels, determining a gain value corresponding to the one of the pixels according to the at least one gain table and the ambient temperature;
compensating the image according to the gain values corresponding to the pixels; and
displaying the compensated image.

7. The image display method of claim 6, wherein each of the at least one gain table is corresponding to a temperature, and when the ambient temperature is equal to the temperature corresponding to one of the at least one gain table, for each of the pixels, the gain value corresponding to the one of the pixels used to compensate the image is the gain value corresponding to the one of the pixels in the one of the at least one gain table.

8. The image display method of claim 7, further comprising:
for each of the pixels, multiplying each gray level value of the one of the pixels by the gain value corresponding to the one of the pixels, so as to compensate the image.

9. The image display method of claim 6, wherein each of the at least one gain table is corresponding to a temperature, and when the ambient temperature is not equal to the temperature corresponding to each of the at least one gain table, the image display method further comprising:
for each of the pixels, calculating the gain value corresponding to the one of the pixels used to compensate the image according to the at least one temperature corresponding to the at least one gain table, the ambient temperature, and at least one gain value corresponding to the one of the pixels in the at least one gain table.

10. The image display method of claim 9, further comprising:
for each of the pixels, multiplying each gray level value of the one of the pixels by the gain value corresponding to the one of the pixels, so as to compensate the image.
